(19) United States
(12) Patent Application Publication
(10) Pub. No.: US 2026/0163705 A1
(43) Pub. Date: Jun. 11, 2026

(54) OPTIMIZING MODEL PERFORMANCE OF USER EQUIPMENTS (UEs) BASED ON COLLECTIVE INTELLIGENCE AT BASE STATION

(71) Applicant: RAKUTEN SYMPHONY, INC., Tokyo (JP)

(72) Inventors: Subramanya CHANDRASHEKAR, Karnataka (IN); Raghavendra Madanahally RAMAKRISHNA, Bangalore, Karnataka (IN)

(73) Assignee: RAKUTEN SYMPHONY, INC., Tokyo (JP)

(21) Appl. No.: 18/702,375

(22) PCT Filed: Feb. 26, 2024
(86) PCT No.: PCT/US2024/017212

§ 371 Date: Apr. 18, 2024

(30) Foreign Application Priority Data
Nov. 30, 2023 (IN) 202341081613

(51) Int. Cl. H04L 5/00

(52) U.S. Cl. CPC H04L 5/0057

(57) ABSTRACT

Embodiments of present disclosure disclose optimizing model performance of UEs based on collective intelligence at base-station. The base-station transmits first segment CSI-RS to plurality of UEs in an area via DL channel corresponding to each of the plurality of UEs. The base-station receives compressed CSI feedback comprising second segment of predicted CSI-RS and one or more CSI parameters from each of the plurality of UEs. The base-station reconstructs CSI-RS associated with each of the plurality of UEs based on CSI feedback received from corresponding UE and first segment. The base-station identifies one or more UEs from plurality of UEs providing an optimized CSI based on predefined threshold-value, using reconstructed CSI-RS. Thereafter, base-station transmits, assistance-information and model-parameters associated with one or more UEs to each of the plurality of UEs, for training corresponding model. Thus, present disclosure improves KPIs of UEs, based on model-parameters and assistance-information of best performing UE(s).

### CROSS-REFERENCE TO RELATED APPLICATION(S)

This application claims the benefit of Indian Provisional Application No 202341081613, entitled “OPTIMIZING MODEL PERFORMANCE OF USER EQUIPMENTS (UEs) BASED ON COLLECTIVE INTELLIGENCE AT BASE STATION” and filed on Nov. 30, 2023, which is expressly incorporated by reference herein in its entirety.

### TECHNICAL FIELD

The present disclosure generally relates to communication technologies, and more specifically, optimizing model performance of UEs based on collective intelligence at base station.

### BACKGROUND

In Third Generation Partnership Project (3GPP), Channel State Information Reference Signal (CSI-RS) is a reference signal that is used in downlink (DL) direction in 5G New Radio (NR), for the purpose of channel sounding and used to measure the characteristics of a radio channel so that it can use correct modulation, code rate, beam forming and the like. In wireless communications, CSI is the known channel properties of a communication link. The CSI information describes how a signal propagates from a transmitter to a receiver and represents the combined effect of, for example, scattering, fading, and power decay with distance. The transmitter is a base station, and the receiver is User Equipment (UE). Further, the CSI makes it possible to adapt transmissions to current channel conditions, which is crucial for achieving reliable communication with high data rates in multiantenna systems.

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

Channel state information (CSI) is information which represents the state of a communication link from the transmit source(s) to the receiver source(s). Currently, the base station or Next Generation Node B (gNB) transmits the CSI-RS in either periodic or aperiodic manner in the DL, using which the UE measures CSI information such as rank, precoder matrix indicator, channel quality indicator and so on. In case of AI-ML based CSI feedback enhancement use-case, all this CSI information is derived assuming common basis functions to reduce the overhead. However, the problem associated with the CSI-RS signal is that the UEs that have same UE capability, reporting similar Reference Signal Received Power (RSRP) and ground truth (i.e., received CSI-RS at UE from gNB) in the same cell often report varying CSI feedback. This is possible due to differences in training and/or inference algorithm used at the UEs. As results, the CSI prediction Key Performance Indicators (KPIs) are impacted and has a direct impact on the “CSI compression” KPIs. Further, if intermediate KPIs of CSI prediction are impacted either due to incorrect model parameters or because of UEs training algorithm, final KPIs are also impacted. In view of the above discussion, there exists a need to optimize model performance of UEs based on collective intelligence at base station to overcome the above-mentioned problems.

In an embodiment, a base station is disclosed. The base station configured to: transmit a first segment of Channel State Information Reference Signal (CSI-RS) to a plurality of User Equipment (UEs) in an area via a downlink physical channel corresponding to each of the plurality of UEs. The base station is configured to receive a compressed CSI feedback comprising a second segment of predicted CSI-RS and one or more CSI parameters from each of the plurality of UEs, wherein the compressed CSI feedback is predicted based on the first segment of CSI-RS using a model associated with each of the plurality of UEs. The base station is configured to reconstruct CSI-RS associated with each of the plurality of UEs based on the CSI feedback received from corresponding UE and the first segment. The base station is configured to identify one or more UEs from the plurality of UEs providing an optimized CSI based on a predefined threshold value, using the reconstructed CSI-RS. Thereafter, the base station is configured to transmit at least one of, assistance information and parameters of a model associated with the one or more UEs to each of the plurality of UEs other than the one or more UEs, for training the corresponding model.

In another embodiment, a method is disclosed. The method includes transmitting, by a base station, a first segment of Channel State Information Reference Signal (CSI-RS) to a plurality of User Equipment (UEs) in an area via a downlink physical channel corresponding to each of the plurality of UEs. The method includes receiving, by the base station, a compressed CSI feedback comprising a second segment of predicted CSI-RS and one or more CSI parameters from each of the plurality of UEs, wherein the compressed CSI feedback is predicted based on the first segment of CSI-RS using a model associated with each of the plurality of UEs. The method includes reconstructing, by the base station, CSI-RS associated with each of the plurality of UEs based on the CSI feedback received from corresponding UE and the first segment. The method includes identifying, by the base station, one or more UEs from the plurality of UEs providing an optimized CSI based on a predefined threshold value, using the reconstructed CSI-RS. The method includes transmitting, by the base station, at least one of, assistance information and parameters of a model associated with the one or more UEs to each of the plurality of UEs other than the one or more UEs, for training the corresponding model.

In yet another embodiment, a non-transitory computer readable medium is disclosed. The non-transitory computer readable medium is configured to: transmit a first segment of Channel State Information Reference Signal (CSI-RS) to a plurality of User Equipment (UEs) in an area via a downlink physical channel corresponding to each of the plurality of UEs. The non-transitory computer readable medium is configured to receive a compressed CSI feedback comprising a second segment of predicted CSI-RS and one or more CSI parameters from each of the plurality of UEs, wherein the compressed CSI feedback is predicted based on the first segment of CSI-RS using a model associated with each of the plurality of UEs. The non-transitory computer readable medium is configured to reconstruct CSI-RS associated with each of the plurality of UEs based on the CSI feedback received from corresponding UE and the first segment. The non-transitory computer readable medium is configured to identify one or more UEs from the plurality of UEs providing an optimized CSI based on a predefined threshold value, using the reconstructed CSI-RS. Thereafter, the non-transitory computer readable medium is configured to transmit at least one of, assistance information and parameters of a model associated with the one or more UEs to each of the plurality of UEs other than the one or more UEs, for training the corresponding model.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. The same numbers are used throughout the figures to reference like features and components. Some embodiments of device and/or methods in accordance with embodiments of the present subject matter are now described, by way of example only, and with reference to the accompanying figures, in which:

FIG. 1 illustrates an exemplary environment for optimizing model performance of UEs based on collective intelligence at base station, in accordance with an embodiment of the present disclosure;

FIG. 2 shows a detailed block diagram of a base station for optimizing model performance of UEs based on collective intelligence at base station, in accordance with an embodiment of the present disclosure;

FIG. 3 illustrates a sequence diagram showing interaction with a base station and UEs optimizing model performance of UEs based on collective intelligence at base station, in accordance with an embodiment of the present disclosure;

FIG. 4 illustrates a flowchart showing an exemplary method for optimizing model performance of UEs based on collective intelligence at base station, in accordance with an embodiment of the present disclosure; and FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

It shall be noted that, for convenience of explanation, the disclosure uses terms and names defined in the 3^{rd} Generation Partnership Project (3GPP) standards. More specifically, the terms ‘Channel State Information Reference Signal (CSI-RS)”, “Reference Signal (RS)”, “User Equipment (UE)”, “base station”, “Next Generation Node B (gNB)”, “cell”, New Radio (NR)”, “gNB-Distributed Unit (DU)”, “gNB-Centralized Unit (CU)”, “Key Performance Indicator (KPI)”, etc are to be interpreted as specified by the 3GPP standards.

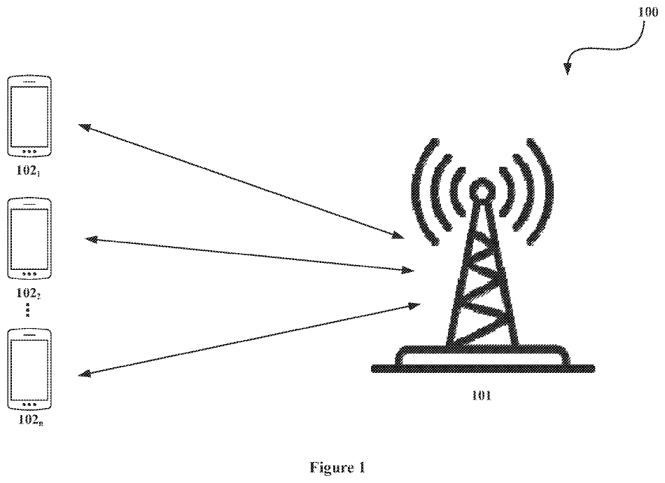

The term “parameters of model” as used herein refers to information used to optimize model performance of UEs based on collective intelligence at base station using model parameters and assistance information. More specifically, the first segment of the CSI-RS is transmitted to a plurality of UEs in an area in a downlink channel. In another embodiment, compressed CSI feedback, comprising a second segment of predicted CSI-RS and CSI parameters, is received. In an embodiment, the compressed CSI feedback is predicted using an Artificial Intelligence (AI)/Machine Learning (ML) model associated with the plurality of UEs. In another embodiment, the CSI-RS associated with each of the plurality of UEs is reconstructed based on the CSI feedback and the first segment. In another embodiment, a UE providing optimized CSI from the plurality of UEs is identified based on predefined threshold value using the reconstructed CSI-RS. In another embodiment, assistance information and parameters of the model associated with the UE is transmitted to the plurality of UEs for training their corresponding model. The assistance information and the parameters of the model of the UE providing the optimized CSI is utilized for training the other UEs in the area to improve KPIs of all the plurality of UEs. In an embodiment, the optimizing model performance of UEs based on collective intelligence at base station using model parameters and assistance information is explained in detail with reference to FIGS. 1-5.

FIG. 1 illustrates an exemplary environment 100 for optimizing model performance of UEs based on collective intelligence at base station using model parameters and assistance information. The exemplary environment 100 includes a base station 101 and a UE 102₁, 102₂ . . . , 102ₙ (herein alternatively referred as plurality of UEs 102). In an embodiment, the base station 101 may include, but is not limited to, gNB, gNB-DU, gNB-CU, a next-generation evolved NodeB (ng-eNB), evolved NodeB (eNB). In an embodiment, the plurality of UEs 102 may include, but is not limited to, a mobile phone, a smartphone and the like. In an embodiment, the base station 101 may interact with the plurality of UEs 102 to optimize the model performance of the UEs based on collective intelligence at the base station 101.

In an embodiment, the base station 101 transmits a first segment of Channel State Information Reference Signal (CSI-RS) to the plurality of UEs 102 in an area via a downlink physical channel corresponding to each of the plurality of UEs 102. In an embodiment, the first segment may be a percentage value of CSI-RS that is transmitted to the plurality of UEs 102. For example, the percentage value may be 60 percent, 40 percent, 30 percent, 90 percent and the like. In an embodiment, the first segment of the CSI-RS is transmitted either periodically or aperiodically to the plurality of UEs 102. Further, the base station 101 receives a compressed CSI feedback comprising a second segment of predicted CSI-RS, the ground truth and one or more CSI parameters from each of the plurality of UEs 102. The compressed CSI feedback is predicted based on the first segment of CSI-RS using a model associated with each of the plurality of UEs 102. In an embodiment, the compressed CSI feedback is received via Physical Uplink Control Channel (PUCCH). In an embodiment, the compressed CSI feedback further comprises Key Performance Indicators (KPIs), assistance information and model parameters corresponding to each of the plurality of UEs 102. In an embodiment, the base station 101 is configured to reconstruct CSI-RS associated with each of the plurality of UEs based on the CSI feedback received from corresponding UE and the first segment. Further, the base station 101 identifies one or more UEs from the plurality of UEs 102 providing an optimized CSI based on a predefined threshold value, using the reconstructed CSI-RS. In an embodiment, the base station 101 compares the reconstructed CSI-RS associated with each of the plurality of UEs 102 with the predefined threshold value. Further, the base station 101 identifies the one or more UEs from the plurality of UEs 102 based on the comparison for providing the optimized CSI. In an embodiment, the reconstructed CSI-RS of the one or more UEs is greater than or equal to the predefined threshold value. Thereafter, the base station transmits at least one of the assistance information and parameters of the model associated with one or more UEs to each of the plurality of UEs 102 other than the one or more UEs, for training the corresponding model. In an embodiment, the assistance information of the one or more UEs comprise spatial frequency, delay-doppler, and domain compression parameters.

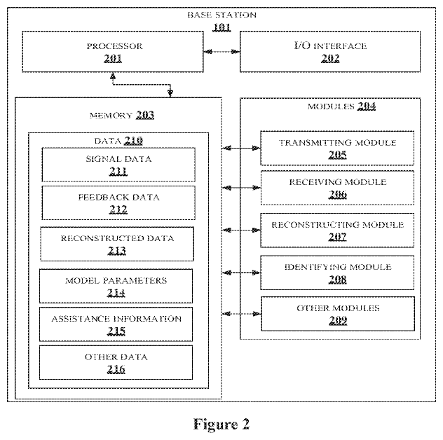

FIG. 2 shows a detailed block diagram of a base station for optimizing model performance of UEs based on collective intelligence at base station, in accordance with an embodiment of the present disclosure.

In an embodiment, the base station 101 may include a processor 201, I/O interface 202, and a memory 203 as shown in FIG. 2. In some embodiments, the memory 203 may be communicatively coupled to the processor 201. The memory 203 stores instructions, executable by the processor 201, which, on execution, may cause the base station 101 for optimizing model performance of UEs based on collective intelligence at base station, as disclosed in the present disclosure. In an embodiment, the memory 203 may include one or more modules 204 and data 210 as shown in FIG. 2. The one or more modules 204 may be configured to perform the procedures of the present disclosure using the data 210, for optimizing model performance of UEs based on collective intelligence at base station. In an embodiment, each of the one or more modules 204 may be a hardware unit which may be outside the memory 203 and coupled with the base station 101.

The data 210 and the one or more modules 204 in the memory 203 of the base station 101 are described herein in detail.

In one implementation, the one or more modules 204 may include, but are not limited to, a transmitting module 205, a receiving module 206, a reconstructing module 207, an identifying module 208, and one or more other modules 209, associated with the base station 101.

In an embodiment, the data 210 in the memory 203 may include signal data 211, feedback data 212, reconstructed data 213, model parameters 214, assistance information 215 and other data 216 associated with the base station 101.

In an embodiment, the data 210 in the memory 203 may be processed by the one or more modules 204 of the base station 101. In an embodiment, the one or more modules 204 may be implemented as dedicated units and when implemented in such a manner, said modules may be configured with the functionality defined in the present disclosure to result in a novel hardware. As used herein, the term module may refer to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality.

One or more modules 204 of the present disclosure function to optimize model performance of UEs based on collective intelligence at base station using model parameters and assistance information. The one or more modules 204 may also include other modules 209 to perform various miscellaneous functionalities of the base station 101. It will be appreciated that such modules may be represented as a single module or a combination of different modules. The one or more modules 204 along with the data 210, may be implemented in any base station, for optimizing model performance of UEs based on collective intelligence at base station using model parameters and assistance information.

The signal data 211 may include information regarding first segment of CSI-RS. In an embodiment, the first segment of CSI-RS is transmitted to plurality of UEs 102.

The feedback data 212 may include information regarding the compressed CSI feedback that comprises second segment of predicted CSI-RS and one or more CSI parameters.

The reconstructed data 213 may include information regarding the reconstructed CSI-RS associated with each of the plurality of UEs 102.

The model parameters 214 may include information such as number of layers, number of nodes per layer in learning network.

The assistance information 215 may include information such as spatial frequency, delay-doppler, and domain compression parameters.

The other data 216 may store data, including temporary data and temporary files, generated by modules for performing the various functions of the base station 101.

In an embodiment, the transmitting module 205 of the base station 101 is configured to transmit the first segment of the CSI-RS to the plurality of UEs 102 that are located in an area. In an embodiment, the plurality of UEs 102 may be present in the same cell. The CSI-RS is a reference signal that is used in downlink direction in 5G New Radio (NR), for the purpose of channel sounding and used to measure the characteristics of a radio channel so that it can use correct modulation, code rate, beam forming and the like. The receiving module 206 of the base station 101 is configured to receive the compressed CSI feedback from each of the plurality of UEs 102. The compressed feedback may include, but is not limited to, a second segment of predicted CSI-RS, the ground truth and one or more CSI parameters. In an embodiment, the compressed CSI feedback also includes KPIs, assistance information and model parameters corresponding to each of the plurality of UEs 102. In an embodiment, each of the plurality of UEs 102 is configured to report important model parameters and their values, and intermediate KPIs of the predicted CSI-RS to the base station 101. In an embodiment, the one or more parameters may include, but not limited to, frequency, bandwidth etc. In an embodiment, the second segment may be a percentage value such as 40 percent, 60 percent, 30 percent and the like. In an embodiment, the compressed CSI feedback is predicted by the models associated with each of the plurality of UEs 102 based on the first segment of CSI-RS. In an embodiment, the models may be trained separately at the base station 101 side and at the plurality of UEs 102 side. In an embodiment, the Plurality of UEs 102 side CSI generation part and at the base station 101 side CSI-RS reconstruction part are trained by the plurality of UEs 102 side and the base station 101 side, respectively. In an embodiment, separate training includes sequential training starting with the plurality of UEs 102 side training. In an embodiment, separate training includes sequential training starting with the base station 101 side training. In another embodiment, separate training includes parallel training at the plurality of UEs 102 side and at the base station 101 side. Further, the reconstructing module 207 of the base station 101 is configured to reconstruct the CSI-RS associated with each of the plurality of UEs 102 based on the CSI feedback received from corresponding UE and the first segment. In an embodiment, the identifying module 208 identifies one or more UEs from the plurality of UEs 102 that provides an optimized CSI based on predefined threshold value using the reconstructed CSI-RS. In an embodiment, the identifying module 208 identifies one or more UEs with the best intermediate KPIs. In another embodiment, the identifying module 208 is configured to compare the reconstructed CSI-RS associated with each of the plurality of UEs 102 with the predefined threshold value. Upon comparing if the reconstructed CSI-RS of the one or more UEs is greater than or equal to the predefined threshold value, the identifying module 208 identifies the one or more UEs for providing the optimized CSI. In an embodiment, the predefined threshold value is ideal KPIs. Thereafter, the transmitting module 205 of the base station 101 is configured to transmit at least one of the assistance information and parameters of the model (alternatively referred as model parameters) associated with the one or more UEs to each of the plurality of UEs 102 other than the one or more UEs. Upon receiving, the plurality of UEs 102 other than the one or more UEs utilize the assistance information and the model parameters to train their corresponding model to provide optimized CSI.

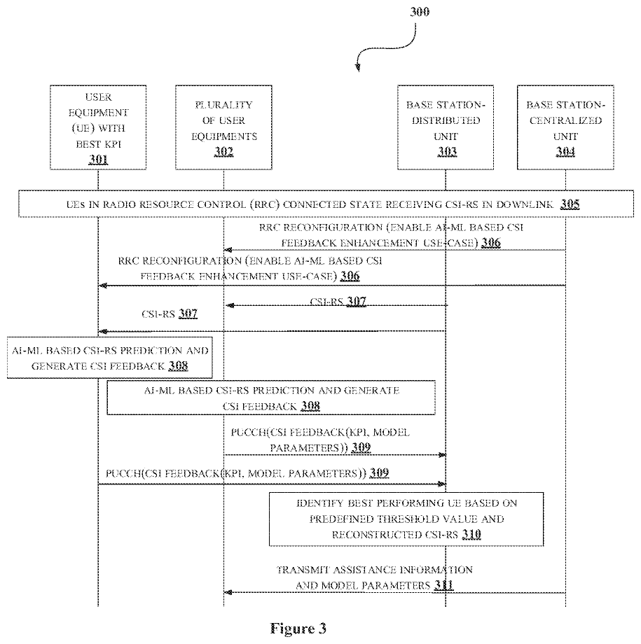

FIG. 3 illustrates a sequence diagram showing interaction with a base station and UEs optimizing model performance of UEs based on collective intelligence at base station, in accordance with an embodiment of the present disclosure. FIG. 3 shows a UE 301 with best KPI, plurality of UEs 302, a base station-distributed unit 303 (alternatively referred as gNB-DU) and a base station-centralized unit 304 (alternatively referred as gNB-CU). Initially, the UE 301 and the plurality of UEs 302 are in Radio Resource Control (RRC) connected state receiving CSI-RS in downlink as shown in FIG. 3 at step 305. In an embodiment, the RRC connection is established, and the bases station has configured the UEs with all the required parameters for communication between them. At step 306, RRC reconfiguration between the gNB-CU 304 and the Plurality of UEs 302 ensures that all the configuration related details are provided to the plurality of UEs. In an embodiment, the UE 301 is a part of the plurality of UEs 302. In an embodiment, the RRC reconfiguration enables AI-ML base CSI feedback enhancement use-case. Further, at step 307, the gNB-DU transmits a percentage of CSI-RS to the plurality of UEs 302 and the UE 301. At step 308, the UE 301 and the plurality of UEs 302 utilizes the AI-ML models and predicts CSI-RS and generates CSI feedback based on the transmitted ground truth CSI-RS. At step 309, the UE 301 and the Plurality of UEs 302 transmits the compressed CSI feedback comprising KPIs and model parameters to the gNB-DU 303 via the PUCCH. In an embodiment, the UE 301 and the plurality of UEs 302 report the important model parameters, their values and the intermediate KPIs of CSI prediction sub-use-case to the network/gNB-DU 303. At step 310, the gNB-DU identifies the UE 301 providing optimized CSI based on the predefined threshold value and the reconstructed CSI-RS. In an embodiment, the gNB-DU monitors the intermediate KPI reported by each UE and identifies the UE with best intermediate KPIs. Further, in an embodiment, the gNB-DU 303 transmits a UE context modification required( ) message to the gNB-CU 304 to initiate re-configuration of parameters of the AI-ML model for CSI feedback enhancement. In another embodiment, the gNB-CU 304 transmits an UE context modification ack( ) message to the gNB-DU 303. Thereafter, at step, 311, the gNB-CU 304 transmits the assistance information and the model parameters of the UE 301 to the plurality of UEs 302 to train their corresponding model. In an embodiment, the plurality of UEs 302 after receiving the assistance information and the model parameters transmits an RRC reconfiguration ack( ) to the gNB-CU 304. In an embodiment, the plurality of UEs 302 receiving the best model parameters and the assistance information from the gNB-CU 304 utilizes them for training at their UE side.

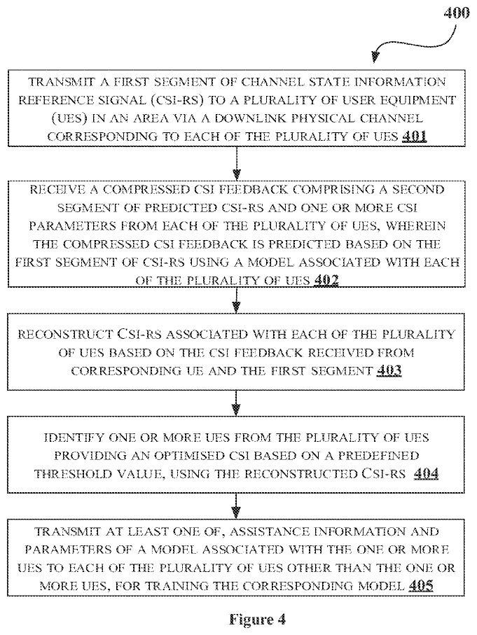

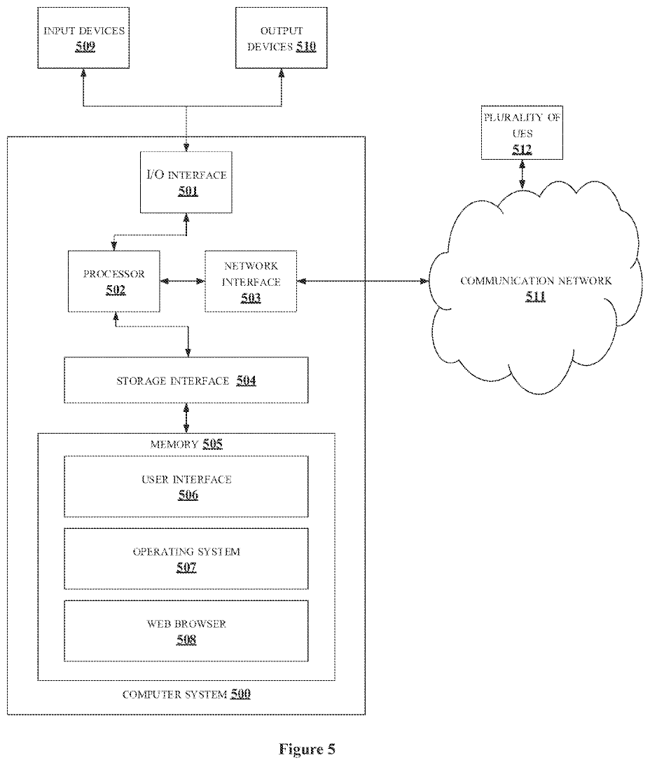

FIG. 4 illustrates a flowchart showing an exemplary method for optimizing model performance of UEs based on collective intelligence at base station, in accordance with an embodiment of the present disclosure.

As illustrated in FIG. 4, the method 400 may include one or more blocks for executing processes in the base station 101. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described may not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 401, transmitting, the first segment of Channel State Information Reference Signal (CSI-RS) to a plurality of User Equipment (UEs) in an area via a downlink physical channel corresponding to each of the plurality of UEs.

At block 402, receiving, the compressed CSI feedback comprising a second segment of predicted CSI-RS and one or more CSI parameters from each of the plurality of UEs, wherein the compressed CSI feedback is predicted based on the first segment of CSI-RS using a model associated with each of the plurality of UEs.

At block 403, reconstructing, the CSI-RS associated with each of the plurality of UEs based on the CSI feedback received from corresponding UE and the first segment.

At block 404, identifying one or more UEs from the plurality of UEs providing an optimized CSI based on a predefined threshold value, using the reconstructed CSI-RS.

At block 405, transmitting, at least one of, assistance information and parameters of a model associated with the one or more UEs to each of the plurality of UEs other than the one or more UEs, for training the corresponding model.

### Computing System

FIG. 5 illustrates a block diagram of an exemplary computer system 500 for implementing embodiments consistent with the present disclosure. In an embodiment, the computer system 500 may be used to implement the base station 101. The computer system 500 may include a central processing unit (“CPU” or “processor”) 502. The processor 502 may include at least one data processor for executing processes in Virtual Storage Area Network. The processor 502 may include specialized processing units such as, integrated system (bus) controllers, memory management control units, floating point units, graphics processing units, digital signal processing units, etc.

The processor 502 may be disposed in communication with one or more input/output (I/O) devices 509 and 510 via I/O interface 501. The I/O interface 501 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n //g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices 509 and 510. For example, the input devices 509 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 510 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 500 may consist of the base station 101. The processor 502 may be disposed in communication with the communication network 511 via a network interface 503. The network interface 503 may communicate with the communication network 511. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 511 may include, without limitation, a direct interconnection, local area network (LAN), wide area network (WAN), wireless network (e.g., using Wireless Application Protocol), the Internet, etc. Using the network interface 503 and the communication network 511, the computer system 500 may communicate with image plurality of UEs 512 for optimizing model performance of UEs based on collective intelligence at base station. The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 511 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as, serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507 etc. In some embodiments, computer system 500 may store user/application data, such as, the data, variables, records, etc., as described in this disclosure. Such databases may be implemented as fault-tolerant, relational, scalable, secure databases such as Oracle ® or Sybase®.

The operating system 507 may facilitate resource management and operation of the computer system 500. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFTTM WINDOWS™ (XPIM, VISTA™/7/8, 10 etc.), APPLE® IOS™, GOOGLE® ANDROID™, BLACKBERRY® OS, or the Like.

In some embodiments, the computer system 500 may implement a web browser 508 stored program component. The web browser 508 may be a hypertext viewing application, such as Microsoft Internet Explorer, Google Chrome, Mozilla Firefox, Apple Safari, etc. Secure web browsing may be provided using Hypertext Transport Protocol Secure (HTTPS), Secure Sockets Layer (SSL), Transport Layer Security (TLS), etc. Web browser 508 may utilize facilities such as AJAX, DHTML, Adobe Flash, JavaScript, Java, Application Programming Interfaces (APIs), etc. In some embodiments, the computer system 500 may implement a mail server stored program component. The mail server may be an Internet mail server such as Microsoft Exchange, or the like. The mail server may utilize facilities such as ASP, ActiveX, ANSI C++/C#, Microsoft .NET, Common Gateway Interface (CGI) scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client stored program component. The mail client may be a mail viewing application, such as Apple Mail, Microsoft Entourage, Microsoft Outlook, Mozilla Thunderbird, etc.

The disclosed method with reference to FIG. 4, or one or more operations of the base station 101 explained with reference to FIGS. 1-3 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

Various embodiments of the present disclosure provide numerous advantages. Embodiments of the present disclosure enables to improve the KPIs of all the UEs, based on the model parameters and the assistance information of the best performing UE(s). Further, the present disclosure may be utilised for all the model training types such as joint training of two side model at a single side/entity (i.e., either network side or UE side), separate training and joint training of the two-sided model at network side and UE side. Further, the gNB-DU of the present disclosure may consider more than one UEs KPI while deriving the best performing model parameters. The present disclosure provides overhead reduction, improved accuracy and prediction of CSI feedback enhancement.

It will be understood by those within the art that, in general, terms used herein, and are generally intended as “open” terms (e.g., the term “including” should be interpreted as “including but not limited to,” the term “having” should be interpreted as “having at least,” the term “includes” should be interpreted as “includes but is not limited to,” etc.). For example, as an aid to understanding, the detail description may contain usage of the introductory phrases “at least one” and “one or more” to introduce recitations. However, the use of such phrases should not be construed to imply that the introduction of a recitation by the indefinite articles “a” or “an” limits any particular part of description containing such introduced recitation to disclosure containing only one such recitation, even when the introductory phrases “one or more” or “at least one” and indefinite articles such as “a” or “an” (e.g., “a” and/or “an” should typically be interpreted to mean “at least one” or “one or more”) are included in the recitations; the same holds true for the use of definite articles used to introduce such recitations. In addition, even if a specific part of the introduced description recitation is explicitly recited, those skilled in the art will recognize that such recitation should typically be interpreted to mean at least the recited number (e.g., the bare recitation of “two recitations,” without other modifiers, typically means at least two recitations or two or more recitations).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following detailed description.

We claim:

1. A base station (101) configured to:
transmit a first segment of Channel State Information Reference Signal (CSI-RS) to a plurality of User Equipment (UEs) (102) in an area via a downlink physical channel corresponding to each of the plurality of UEs (102);
receive a compressed CSI feedback comprising a second segment of predicted CSI-RS and one or more CSI parameters from each of the plurality of UEs, wherein the compressed CSI feedback is predicted based on the first segment of CSI-RS using a model associated with each of the plurality of UEs;
reconstruct CSI-RS associated with each of the plurality of UEs based on the CSI feedback received from corresponding UE and the first segment;
identify one or more UEs from the plurality of UEs providing an optimized CSI based on a predefined threshold value, using the reconstructed CSI-RS; and
transmit at least one of, assistance information and parameters of a model associated with the one or more UEs to each of the plurality of UEs other than the one or more UEs, for training the corresponding model.

2. The base station (101) as claimed in claim 1, wherein the first segment of CSI-RS is transmitted periodically to the plurality of UEs (102).

3. The base station (101) as claimed in claim 1, wherein the first segment of CSI-RS is transmitted aperiodically to the plurality of UEs (102).

4. The base station (101) as claimed in claim 1, wherein the compressed CSI feedback is received via a Physical Uplink Control Channel (PUCCH).

5. The base station (101) as claimed in claim 1, wherein the compressed CSI feedback further comprises Key Performance Indicators (KPIs), assistance information and model parameters corresponding to each of the plurality of UEs (102).

6. The base station (101) as claimed in claim 1, configured to:
compare the reconstructed CSI-RS associated with each of the plurality of UEs (102) with the predefined threshold value; and
identify the one or more UEs from the plurality of UEs (102) based on the comparison for providing the optimized CSI, wherein the reconstructed CSI-RS of the one or more UEs is greater than or equal to the predefined threshold value.

7. The base station (101) as claimed in claim 1, wherein the assistance information of the one or more UEs comprises spatial frequency, delay-doppler, and domain compression parameters.

8. A method, comprising:
transmitting, by a base station (101), a first segment of Channel State Information Reference Signal (CSI-RS) to a plurality of User Equipment (UEs) (102) in an area via a downlink physical channel corresponding to each of the plurality of UEs (102);
receiving, by the base station (101), a compressed CSI feedback comprising a second segment of predicted CSI-RS and one or more CSI parameters from each of the plurality of UEs (102), wherein the compressed CSI feedback is predicted based on the first segment of CSI-RS using a model associated with each of the plurality of UEs (102);
reconstructing, by the base station (101), CSI-RS associated with each of the plurality of UEs (102) based on the CSI feedback received from corresponding UE and the first segment;
identifying, by the base station (101), one or more UEs from the plurality of UEs (102) providing an optimized CSI based on a predefined threshold value, using the reconstructed CSI-RS; and
transmitting, by the base station (101), at least one of, assistance information and parameters of a model associated with the one or more UEs to each of the plurality of UEs (102) other than the one or more UEs, for training the corresponding model.

9. The method as claimed in claim 8, wherein the first segment of CSI-RS is transmitted periodically to the plurality of UEs (102).

10. The method as claimed in claim 8, wherein the first segment of CSI-RS is transmitted aperiodically to the plurality of UEs (102).

11. The method as claimed in claim 8, wherein the compressed CSI feedback is received via a Physical Uplink Control Channel (PUCCH).

12. The method as claimed in claim 8, wherein the compressed CSI feedback further comprises Key Performance Indicators (KPIs), assistance information and model parameters corresponding to each of the plurality of UEs (102).

13. The method as claimed in claim 8, comprising:
comparing, by the base station (101), the reconstructed CSI-RS associated with each of the plurality of UEs (102) with the predefined threshold value; and
identifying, by the base station (101), the one or more UEs from the plurality of UEs (102) based on the comparison for providing the optimized CSI, wherein the reconstructed CSI-RS of the one or more UEs is greater than or equal to the predefined threshold value.

14. The method as claimed in claim 8, wherein the assistance information of the one or more UEs comprises spatial frequency, delay-doppler, and domain compression parameters.

15. A non-transitory computer readable medium including instructions for performing operation comprising:
transmit a first segment of Channel State Information Reference Signal (CSI-RS) to a plurality of User Equipment (UEs) (102) in an area via a downlink physical channel corresponding to each of the plurality of UEs (102);
receive a compressed CSI feedback comprising a second segment of predicted CSI-RS and one or more CSI parameters from each of the plurality of UEs (102), wherein the compressed CSI feedback is predicted based on the first segment of CSI-RS using a model associated with each of the plurality of UEs (102);
reconstruct CSI-RS associated with each of the plurality of UEs (102) based on the CSI feedback received from corresponding UE and the first segment;
identify one or more UEs from the plurality of UEs (102) providing an optimized CSI based on a predefined threshold value, using the reconstructed CSI-RS; and
transmit at least one of, assistance information and parameters of a model associated with the one or more UEs to each of the plurality of UEs (102) other than the one or more UEs, for training the corresponding model.
